(19) United States
(12) Patent Application Publication
(10) Pub. No.: US 2013/0284944 A1
(43) Pub. Date: Oct. 31, 2013

(54) INSULATOR AND USE THEREOF

(71) Applicants: Hiromu Kashida, Nagoya-shi (JP); Hiroyuki Asanuma, Nagoya-shi (JP); Koji Sekiguchi, Nagoya-shi (JP); Naofumi Higashiyama, Nagoya-shi (JP)

(72) Inventors: Hiromu Kashida, Nagoya-shi (JP); Hiroyuki Asanuma, Nagoya-shi (JP); Koji Sekiguchi, Nagoya-shi (JP); Naofumi Higashiyama, Nagoya-shi (JP)

(73) Assignee: NATIONAL UNIVERSITY CORPORATION NAGOYA UNIVERSITY, Nagoya-shi, Aichi (JP)

(21) Appl. No.: 13/580,677

(22) PCT Filed: Feb. 28, 2011
(86) PCT No.: PCT/JP2011/054555

§ 371 Date: Dec. 5, 2012

(30) Foreign Application Priority Data
Feb. 26, 2010 (JP) 2010-042632

(51) Int. Cl. H01B 3/18; G01N 21/64

(52) U.S. Cl. CPC H01B 3/18; G01N 21/64
USPC 250/459.1; 558/173; 546/37; 536/23.1

(57) ABSTRACT

An object of the present invention is to provide an insulator which can suppress quenching between fluorescent dyes and enhance fluorescence intensity. The present invention provides, in order to achieve this object, an insulator which contains a ring entity of nonplanar structure and suppresses reduction in fluorescence intensity of one or two or more fluorescent labels adjacent to the insulator.

### TECHNICAL FIELD

This application claims priority to Japanese Patent Application No. 2010-042632 filed on Feb. 26, 2010, the contents of which are hereby incorporated by reference into the present application.

The present application relates to an insulator and use thereof.

### DESCRIPTION OF RELATED ART

Biological molecules such as nucleic acids and proteins may be labeled in a procedure such that a single molecule of a fluorescent dye such as fluorescein or Cy3 is attached. According to this procedure, detection intensity depends on fluorescence intensity of the single molecule of the fluorescent dye. Fluorescence intensity is proportional to two properties of the fluorescent dye: light absorption and quantum yield. Although fluorescent dyes have high quantum yields, they do not produce high fluorescence intensity because they are used in a single molecule and thus provide low absorption of light.

In addition it is known that there is a phenomenon in which, when the fluorescent dye is attached to nucleic acid such as DNA, the fluorescent dye is quenched due to a nucleobase such as guanine or thymine of an adjacent nucleotide, resulting in reduction of fluorescence intensity. For addressing this problem an insulator molecule is proposed which suppresses quenching due to an adjacent nucleobase (Non Patent Literature 1)

### CITATION LIST

### Non Patent Literature

Non Patent Literature 1 J. N. Wilson et al. ChemBioChem, 2008, 9, 279-285

### BRIEF SUMMARY OF INVENTION

The present inventors preconceived that in order to improve low detection sensitivity due to the limited used of a single molecule of a fluorescent dye, multiple molecules of the fluorescent dye may be effectively attached to increase light absorption and thus fluorescence intensity. However, there has been a problem that when multiple fluorescent dyes are introduced, most of the fluorescent dyes form dimers to reduce quantum yield, resulting in quenching. The insulator molecule disclosed in Non Patent Literature 1 does not intend to suppress the quenching phenomenon upon attachment of multiple fluorescent dyes, but aims to suppress the quenching phenomenon due to a base of a nucleotide adjacent to the fluorescent dye. Accordingly, it has not been known whether the insulator molecule of Non Patent Literature 1 can suppress quenching between fluorescent dyes. In addition, no report has been currently made that allows prediction of structures effective for suppression of quenching between fluorescent dyes.

Nucleobases of adjacent nucleotides may sometimes have a significant impact depending on the type of the fluorescent dye. However, J. N. Wilson et al. ChemBioChem, 2008, 9, 279-285 merely discloses insulator molecules preferable to be introduced between two kinds of fluorescent dyes, aminopurine and pyrene, and a base of a nucleotide.

Therefore, the present disclosure has an objective to provide an insulator and the use thereof, which can suppress an influence from an adjacent fluorescent dye or nucleobase and thus increase fluorescence intensity of the fluorescent dye.

The present inventors have studied various insulators which can suppress electron transfer between adjacent fluorescent dyes and found that certain backbones of the insulators are effective for suppression of electron transfer. They have also found that by using insulators having such backbones, fluorescence intensity can be increased by accumulating fluorescent dyes. They have also confirmed an insulator function on the bases for suppressing quenching of the fluorescent dye due to nucleobases of adjacent nucleotides. Based on these finding, the following configurations are provided.

According to the present disclosure, an insulator is provided which contains a ring entity of nonplanar structure and enhances fluorescence intensity of one or two or more fluorescent labels adjacent to the insulator. The ring entity may be selected from monocyclic entities having 4 to 7 carbon atoms and ring entities having two or more rings with 8 to 12 carbon atoms. The ring entity may be at least one monocyclic alkane having 4 or more and 7 or less carbon atoms. The ring entity may also be a cyclohexane derivative.

According to the present disclosure, a backbone structure containing a nucleobase is provided which comprises one or two or more fluorescent label units containing a fluorescent label and one or two or more insulator units containing a molecule having a ring entity of nonplanar structure, the fluorescent label unit being linked to the backbone structure and the one or two or more insulator units being arranged so as to be adjacent to the fluorescent label unit on one or both sides thereof. The backbone structure may contain the fluorescent label unit between the insulator units. The backbone structure may contain the fluorescent label unit in the structure or at the end portion(s) thereof (5′ terminal and/or 3′ terminal). When, particularly, the backbone structure comprises a complementary strand based on base pairing, it may contain the fluorescent label unit together with the insulator unit within the duplex, or may contain them at a non-double stranded part, i.e. at the end portion(s) (5′ terminal and/or 3′ terminal).

According to the present disclosure, a labeling agent comprising the above structure is provided. The labeling agent may comprise the fluorescent label unit and the insulator unit in a backbone comprising a nucleobase and/or in a complementary strand of the backbone. The labeling agent may comprise the insulator unit in the backbone and/or in the complementary strand thereof such that at least one molecule is placed between two fluorescent labels. Further, the labeling agent may comprise the insulator unit in the backbone and/or the complementary strand thereof such that at least one molecule is placed at each side of one fluorescent label. Further, the labeling agent may comprise two or more fluorescent label units.

The fluorescent label unit may be the one represented by the following formula (1):

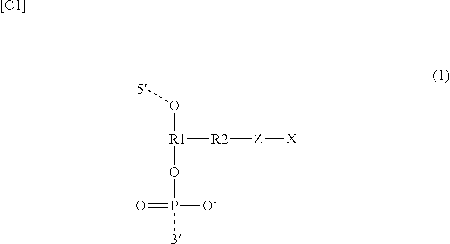

where X represents a fluorescent label, R1 represents an optionally substituted alkylene chain having 2 or 3 carbon atoms, R2 represents an optionally substituted alkylene chain having 0 to 2 carbon atoms and Z represents a direct bond or a linking group.

The insulator unit may be the one represented by the following formula (2):

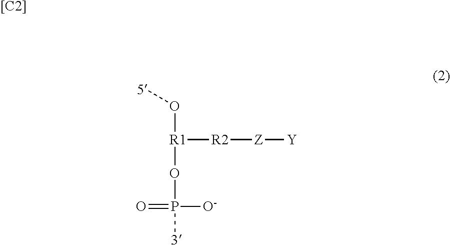

where Y represents an insulator, R1 represents an optionally substituted alkylene chain having 2 or 3 carbon atoms, R2 represents an optionally substituted alkylene chain having 0 to 2 or less carbon atoms and Z represents a direct bond or a linking group.

The fluorescent label may be selected from the group consisting of cyanine-based dyes, merocyanine-based dyes, condensed aromatic ring-based dyes, xanthene-based dyes, coumarin-based dyes and acridine-based dyes.

Further, according to the present disclosure, a compound containing the insulator is also provided. Thus, the present compound comprises the insulator having the ring entity of nonplanar structure and is represented by the following formula (3):

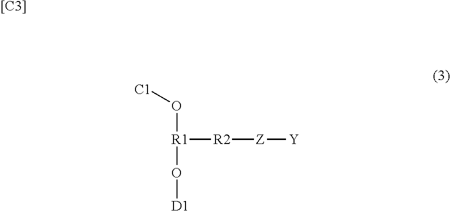

where Y represents the insulator, R1 represents an optionally substituted alkylene chain having 2 or 3 carbon atoms, R2 represents an optionally substituted alkylene chain having 0 to 2 carbon atoms, Z represents a direct bond or a linking group, C1 represents a hydrogen atom or a hydroxyl protecting group and D1 represents a hydrogen atom, a hydroxyl protecting group, a phosphoramidite group or a linking group which is to be attached or has been attached to a solid support.

According to the present disclosure, a method for detection of a biological molecule is provided which comprises a step of detecting a biological molecule according to a signal based on the fluorescent label of the labeling agent.

### BRIEF DESCRIPTION OF DRAWINGS

FIG. 1 is a diagram showing an example of the labeling agent disclosed herein;

FIG. 2 is a diagram showing another example of the labeling agent disclosed herein;

FIG. 3 is a diagram showing yet another example of the labeling agent disclosed herein;

FIG. 4 is a diagram showing yet another example of the labeling agent disclosed herein;

FIG. 5 is a diagram showing the results of fluorescence intensity measurement of a duplex oligonucleotide having the insulator adjacent to the fluorescent label (pyrene) in Example 4;

FIG. 6 is a diagram showing the results of fluorescence intensity measurement of the duplex oligonucleotide having the insulator adjacent to the fluorescent label (perylenebisimide) in Example 6;

FIG. 7 is s a diagram showing the results of fluorescence intensity measurement of the duplex oligonucleotide having the insulator placed between multiple fluorescent labels (pyrene) in Example 8;

FIG. 8 is a diagram showing the fluorescent label unit (F) and the insulator unit (H) in the oligonucleotide synthesized in Example 9 and the configuration of the duplex oligonucleotide base-pairing with a complementary strand;

FIG. 9 is a diagram showing the results of fluorescence intensity measurement of the duplex oligonucleotide having the fluorescent label unit and the insulator unit(s) at a terminal, with the upper panel showing the results at pH 7 and the lower panel showing the results at pH 9;

FIG. 10 is a diagram showing the results of fluorescence intensity measurement of the duplex oligonucleotide in Example 11; and

FIG. 11 is a diagram showing the results of fluorescence intensity measurement of single-strand and duplex oligonucleotides in Example 12.

### DETAILED DESCRIPTION OF INVENTION

The present disclosure relates to the insulator, a nucleoside derivative comprising the insulator, as well as the labeling agent comprising the insulator unit which comprises the insulator. The insulator disclosed herein is placed between two fluorescent labels or adjacent to one fluorescent label, so that it suppresses electron transfer between these fluorescent labels or between the fluorescent label and the adjacent nucleobase and suppresses reduction in a yield of the fluorescent label, thereby suppressing quenching. Due to this, fluorescence intensity of the fluorescent label can be enhanced. Without wishing to limit the present disclosure, it is inferred that such suppression of electron transfer is produced by disturbing the stacking of bases or dyes with the ring entity of nonplanar structure.

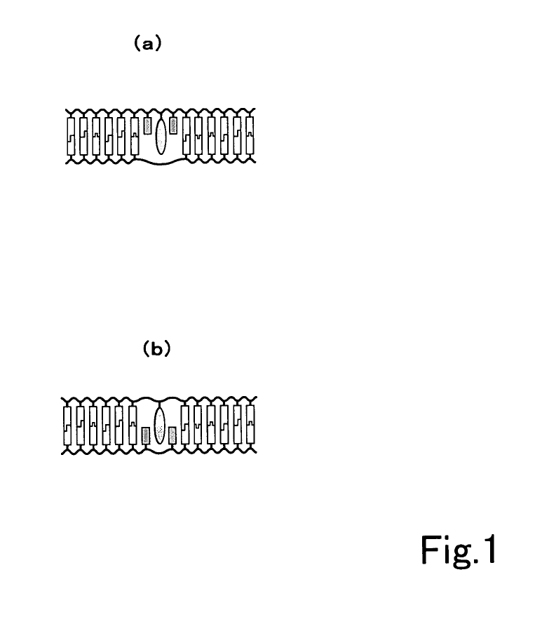

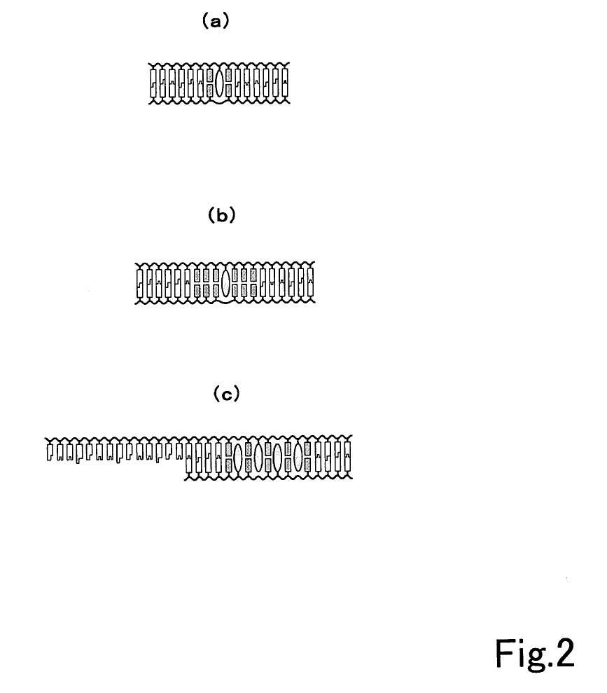

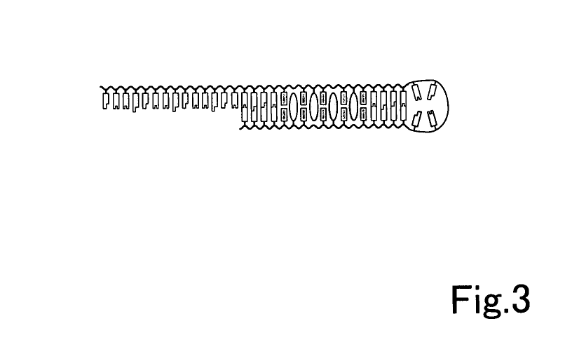

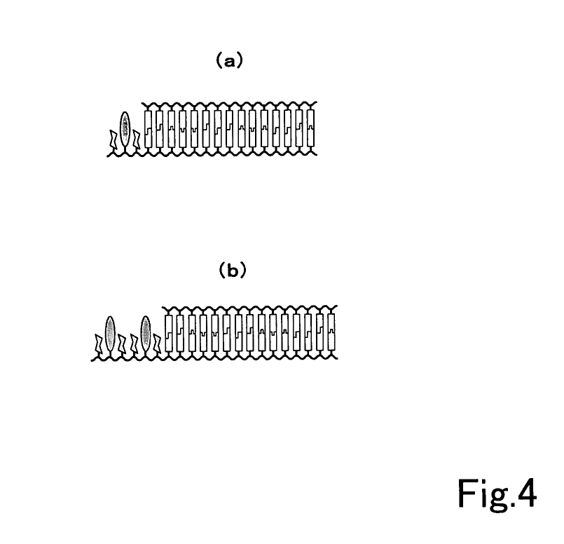

Such insulator can provide the labeling agent having superior detection sensitivity, the nucleoside derivative which may be used for the labeling agent and the like, an amidite derivative, the method for detection of a biomolecule using such a labeling agent. Various embodiments comprised in the present disclosure are now described with appropriately referring to the drawings. FIG. 1 is a diagram showing an example of the labeling agent disclosed herein, FIG. 2 is a diagram showing another example and FIG. 3 is a diagram showing yet another example. FIG. 4 is a diagram showing yet another example.

### Insulator

The insulator disclosed herein is a molecule or a group substantially retaining the structure thereof which is placed to be adjacent to one or two or more fluorescent labels and suppresses electron transfer to the adjacent fluorescent dye as well as to the possible adjacent nucleobase, thereby suppressing reduction in fluorescence intensity of the fluorescent label. Due to this, the insulator acts as an enhancing agent which enhances fluorescence intensity of the fluorescent dye. By suppressing electron transfer to the nucleobases or fluorescent dye by placing the insulator therebetween, luminescence intensity of the fluorescent label whose luminescence intensity is prone to be affected by pH can be enhanced regardless of pH. Due to this, the fluorescent label, which is required to apply a pH that is different from the one in a hybridization step upon detection of fluorescence, can have less requirements in the pH range and have greater flexibility in selection of pH upon detection of fluorescence, thereby allowing simplification or omission of pH adjustment in experimental procedures.

### Ring Entity

The present insulator has one or two or more ring entities of nonplanar structure. “Nonplanar structure” refers to tertiary structure of the ring entity, which is nonplanar, and “having nonplanar structure” means that such nonplanar structure is accepted. Such ring entity may include, for example, a ring entity comprising at least two bonds which are allowed to rotate around their bond axes and more specifically include a ring entity having two or more carbon-carbon bonds including sp3 bonding mode. Such ring entity may include various monocyclic hydrocarbons, bridged cyclic hydrocarbons, spiro hydrocarbons and derivatives thereof.

The ring entity may include, for example, monocyclic entities having 4 or more and 7 or less carbon atoms. Namely, the ring entity may include cyclobutane, cyclopentane, cyclohexane, cycloheptane, cyclopentene, cyclohexene, cycloheptene and derivatives thereof. Among these, the ring entity is preferably at least one monocyclic alkane having 4 or more and 7 or less carbon atoms and more preferably cyclohexane or derivatives thereof. The ring entity may also include, for example, ring entities having two or more rings with 8 or more and 12 or less carbon atoms. The ring entity having two or more rings may be a bridged cyclic hydrocarbon, a Spiro cyclic hydrocarbon or a ring assembly.

One or two or more hydrogen atoms linked to the ring entity may be substituted. A substituent is not specifically limited and may include a hydrocarbon group such as an alkyl, alkenyl or alkynyl group which is linear or branched and has 1 or more and 8 or less carbon atoms. The substituent is preferably an alkyl group and more preferably an alkyl group which is linear or branched and has 1 or more and 5 or less carbon atoms.

Such ring entity may include, for example, the following compounds. The following compounds are represented such that they include a linking portion to a main chain or unit described below. The linking portion is not limited to the one depicted and may be appropriately selected.

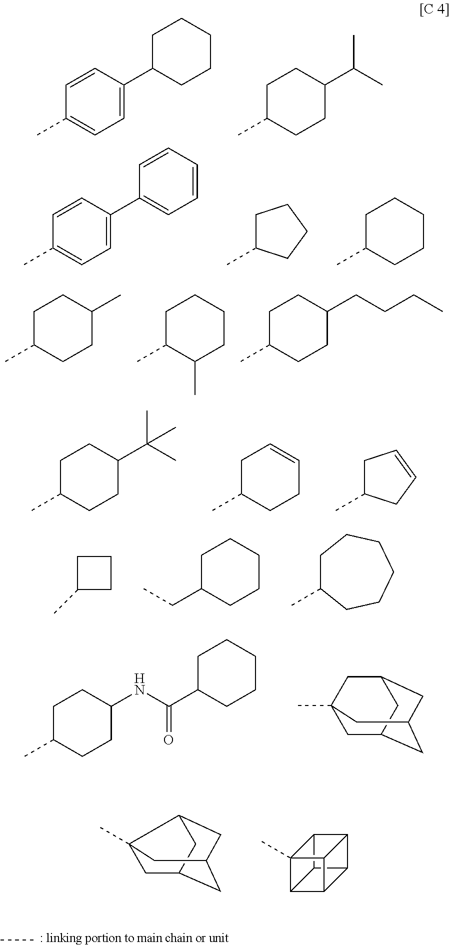

The insulator comprises, in addition to the ring entity, an aromatic ring, which may be directly linked to the ring entity via a carbon-carbon bond or may be indirectly linked through an appropriate linking group. The insulator may also comprise, in order to be adjacent to the fluorescent label comprised in the main chain or backbone comprising a nucleobase described hereinbelow, a linking group for linking to the main chain or backbone or a complementary strand thereof.

### Fluorescent Label

The insulator is used so as to be adjacent to one or two or more fluorescent labels. Usually, as described below, it is used as the insulator in the labeling agent comprising the fluorescent label. The fluorescent label employed may be a well known fluorescent label without limitation and may include, for example, cyanine-based dyes, merocyanine-based dyes, acridine-based dyes, coumarin-based dyes, ethidium-based dyes, flavin-based dyes, condensed aromatic ring-based dyes, xanthene-based dyes and the like. The fluorescent label may be appropriately selected among them. Specifically, cyanine-based dyes, coumarin-based dyes, ethidium-based dyes, condensed aromatic ring-based dyes and xanthene-based dyes are preferred. More specifically, the fluorescent label is selected from the group consisting of Cy3, Cy5, thiazole orange, oxazole yellow, pyrene, perylene, perylenebisimide, fluorescein, rhodamine, tetramethylrhodamine and Texas red and derivatives thereof.

Particularly, perylenebisimide is preferred because it is photochemically stable and highly resistant to photobleaching compared to other fluorescent dyes. By combining perylenebisimide with the insulator of the present invention, quantum yield can be obtained which is equivalent or higher than other fluorescent dyes. Suitable perylenebisimide according to the present invention is represented by the following formula A:

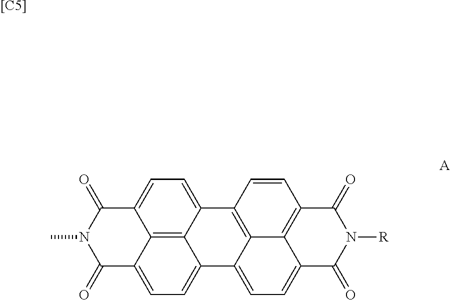

wherein R represents an alky group, preferably a branched alkyl group, preferably a C₁ to C₈ and more preferably C₂ to C₅ branched alkyl group and particularly an isopropyl group.

The fluorescent label whose fluorescence intensity varies according to pH may include xanthene-based dyes. Among these, a fluorescent label which is quenched upon protonation may be mentioned. Such fluorescent label may include, for example, the following labels. In each formula shown below, a linking group to the unit is exemplified by —CO— which however does not limit the linking group.

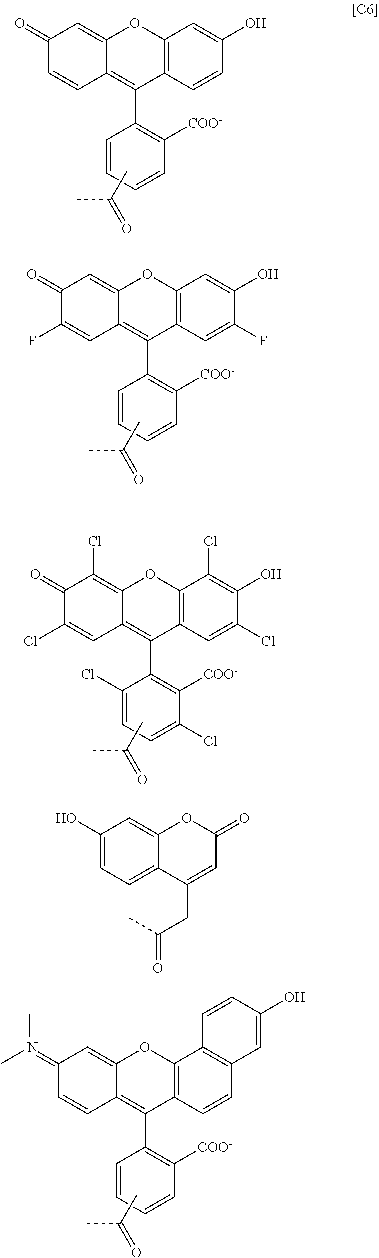

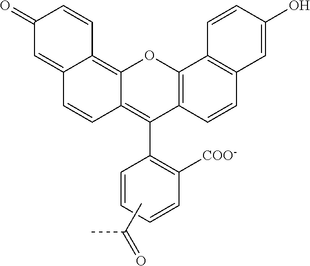

The fluorescent label may be adjacent to the insulator in any mode. For example, these may be comprised adjacently in a structure that is acceptable for known labeling agents. For example, one or two or more fluorescent labels may be comprised in an appropriate polymer main chain which comprises more than one reactive group selected from an amino group, a SH group, an aldehyde group, a carboxyl group and a hydroxyl group or in “the backbone structure containing a nucleobase” that is one mode of the main chain. The nucleobase may include natural adenine (A), thymine (T), guanine (G), cytosine (C) and uracil (U) and derivatives thereof. The backbone structure containing the nucleobase is not specifically limited, but preferably has a structure capable of forming a base paired duplex of nucleobases with a complementary base sequence. For example, The backbone structure may include a phosphate-saccharide backbone in which pentoses such as riboses or deoxyriboses are connected via phosphodiester bonds, a peptide backbone containing a peptide bond such as PNA and a backbone of a phosphate-alkylene chain as disclosed hereinbelow. Such backbone structure may be synthesized or available as oligonucleotides, polynucleotides or derivatives thereof or PNA.

The “backbone structure containing a nucleobase” which is one mode of the main chain preferably comprises usually 2 or more nucleobases and may have, for example, 10-mer or more and 100-mer or less in length. The number of the nucleobases is not particularly limited and the one with above 100-mer may be included in the present backbone structure. The backbone structure may be a single strand or duplex which contains a complementary strand by base pairing. The complementary strand in this context means a backbone structure which contains a base, or a sequence thereof, of a nucleobase capable of base-pairing with a base or a sequence thereof of the backbone structure in the form of a single strand.

Such insulator can suppress, when it is adjacent to the fluorescent label, electron transfer from the fluorescent label to another electron-acceptable compound which is separated from the fluorescent label by the insulator such as a nucleobase or another fluorescent label, suppress reduction in quantum yield of the fluorescent label as well as suppress reduction in fluorescence intensity and as a result, enhance fluorescence intensity compared to the case when the insulator is absent (the insulator is not adjacent). Thus, the present insulator is a component of the labeling agent having better sensitivity.

One or two or more present insulators can be placed between one fluorescent label and another fluorescent label to suppress electron transfer between these fluorescent labels. Alternatively, one or two or more present insulators can be placed between a fluorescent label and a nucleobase to suppress electron transfer between them. Thus, one or two or more preset insulators may be provided between one fluorescent label and another fluorescent label or between a fluorescent label and a nucleobase. The insulator(s) may also be provided so as to be adjacent to one or both fluorescent labels.

When the number of the present insulators placed between the nucleobase(s) or fluorescent label(s) which is to be suppressed for its effect is increased, suppression efficacy of electron transfer tends to be increased. Accordingly, the number of the present insulators is, in view of the suppression efficacy of electron transfer, preferably two or more, more preferably 3 or more and still more preferably 4 or more.

### Labeling Agent

The labeling agent disclosed herein comprises one or two or more fluorescent label unit having the fluorescent label and the insulator unit containing the insulator having the ring entity of nonplanar structure, wherein the insulator unit is comprised such that the insulator is placed adjacent to one or two or more fluorescent labels. The insulator which has the ring entity of nonplanar structure is the insulator disclosed herein.

The structure of the present labeling agent is not particularly limited so long as the fluorescent label unit and the insulator unit are placed so that the insulator is adjacent to the fluorescent label. For example, the labeling agent may be built by attaching one or two or more fluorescent labels to an appropriate polymer main chain having more than one reactive group selected from an amino group, a SH group, an aldehyde group, a carboxyl group and a hydroxyl group, as described above, and then attaching one or two or more insulators to the reactive groups on the same main chain so that the insulator(s) is adjacent to one or both fluorescent labels. In this case, the fluorescent label(s) and the insulator(s) are placed on a single main chain. In other words, the fluorescent label unit(s) and the insulator unit(s) are linked in this structure.

It is preferable that the fluorescent label unit and the insulator unit in the present labeling agent are comprised in the backbone structure comprising a nucleobase as described above. Namely, they may be comprised in the backbone structure in the form of a single strand or in one or both strands of a duplex backbone structure. When these units are comprised in the backbone structure in the form of a single strand, multiple fluorescent labels may be provided so as to be stacked together and the insulator can be easily introduced between fluorescent labels or between the fluorescent label and an adjacent base. When these units are comprised in one or both strands of the duplex backbone structure, the insulator can be effectively placed between fluorescent labels or between the fluorescent label and the nucleobase by utilizing the base-pairing between the duplex, so that superior function of the insulator can be effectively obtained. The fluorescent label unit having perylenebisimide represented by the formula A may be suitably mentioned.

### Fluorescent Label Unit

The fluorescent label unit is a unit which has the fluorescent label and constitutes the labeling agent. The portion which constitutes the unit other than the fluorescent label may have various structures according to the type of the main chain or backbone structure. When the backbone has the phosphate-saccharide backbone structure, the fluorescent label unit may have the phosphate-saccharide portion. Namely, the fluorescent label unit may comprise a skeletal unit other than a base of a nucleotide unit constituting an oligonucleotide. When the backbone structure has a PNA backbone structure, the fluorescent label unit may comprise a skeletal unit of the PNA. When the backbone structure has the phosphate-alkylene chain backbone, the fluorescent label unit may comprise a skeletal unit of the phosphate-alkylene chain. The phosphate-alkylene chain backbone is advantageous for the present labeling agent because it can be easily synthesized. Alternatively, the fluorescent label unit does not necessarily have the structure according to the type of the main chain or backbone. For example, even when the backbone is the phosphate-saccharide backbone, the fluorescent label unit may have the skeletal unit of the phosphate-alkylene chain. The fluorescent label unit constituting the phosphate-alkylene chain backbone may be represented by the following formula (1):

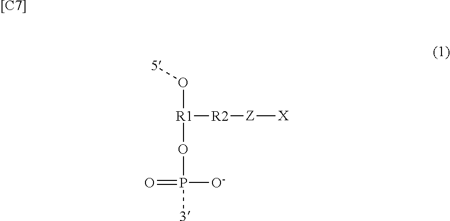

wherein X represents the fluorescent label, R1 represents an optionally substituted alkylene chain having 2 or 3 carbon atoms, R2 represents an optionally substituted alkylene chain having 0 or more and 2 or less carbon atoms and Z represents a direct bond or a linking group.

It is preferable that R2 is attached to the second carbon atom from the oxygen atom at the 5′ side of the alkylene chain of R1. The linking group, Z may include, for example, —NHCO—, —NHCS—, —CONH—, —O— and the like or a group containing these groups. In the linking portions (shown with the dotted lines) to the linking group, an optionally substituted alkylene, alkenylene or alkynylene group may be intervened considering the size of the fluorescent label or the relationship with the insulator. The compound to be used as the fluorescent label may be appropriately derivatized so as to be linked to the unit represented by the formula (1). Any atom on the fluorescent label may be linked to the unit represented by the formula (1) without limitation.

### Insulator Unit

The insulator unit is a unit which has the insulator and constitutes the labeling agent. Similar to the fluorescent label unit, the portion which constitutes the unit other than the insulator may have the structure according to the type of the main chain or backbone or may have a different structure. The insulator unit constituting the phosphate-alkylene chain backbone may be represented by the following formula (2):

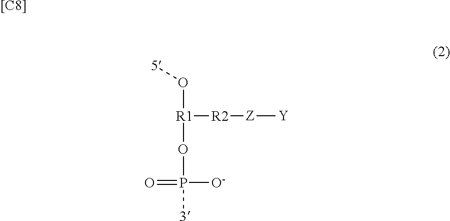

wherein Y represents the insulator, R1 represents an optionally substituted alkylene chain having 2 or 3 carbon atoms, R2 represents an optionally substituted alkylene chain having 0 or more and 2 or less carbon atoms and Z represents a direct bond or a linking group.

R1, R2 and Z in the formula (2) have the same meanings as those in the formula (1). In the linking portions (shown with the dotted lines) to the linking group, an optionally substituted alkylene, alkenylene or allcynylene group may be intervened considering the desired distance to the adjacent fluorescent label or the relationship with the insulator in a base-paired stand. The compound to be used as the insulator may be appropriately derivatized so as to be linked to the unit represented by the formula (2). Any atom on the insulator may be connected to the unit represented by the formula (2) without limitation.

The substituent of the above R1 and R2 in the formulae (1) and (2) may include an alkyl or alkoxy group which may be unsubstituted or substituted with a halogen atom, a hydroxyl, amino, nitro, carboxyl group or the like and has 1 to 20, preferably 1 to 10, more preferably 1 to 4 carbon atoms; an alkenyl or alkynyl group which may be unsubstituted or substituted with a halogen atom, a hydroxyl, amino, nitro, carboxy group or the like and has 2 to 20, preferably 2 to 10, more preferably 2 to 4 carbon atoms; a hydroxyl group, a halogen atom, an amino group, a nitro group or a carboxy group. The substituent of R1 may be linked to any carbon atom on the alkylene chain, however, it is preferably linked to the second or third carbon atom from the 5′ oxygen atom.

The alkylene chains of R1 in the formulae (1) and (2) of the fluorescent label unit and the insulator unit in the same labeling agent may have the same or different number of carbon atoms.

For example, the unit represented by the formula (1) or (2) may include the followings.

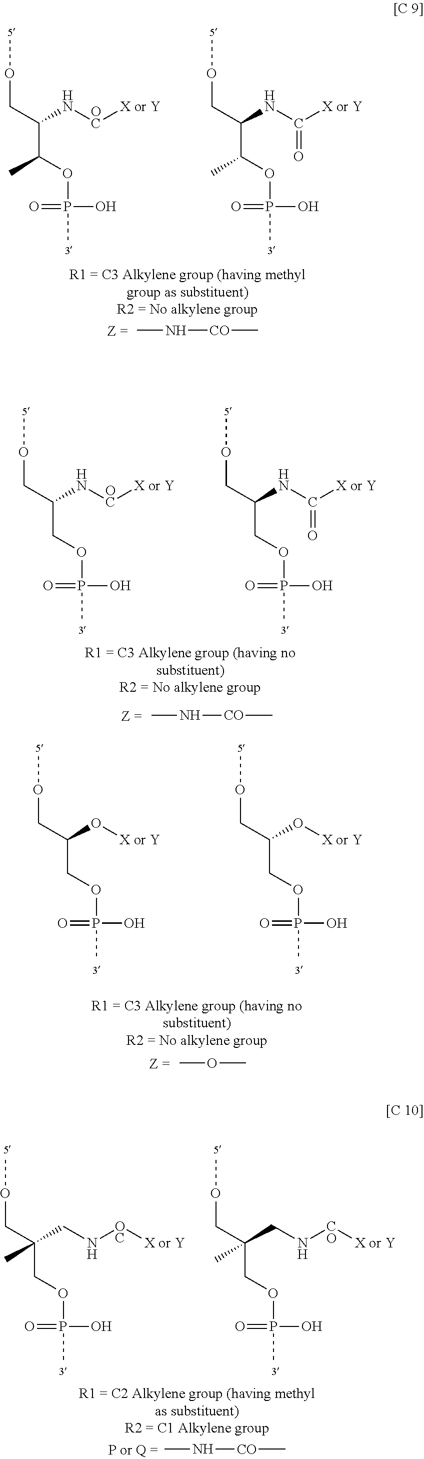

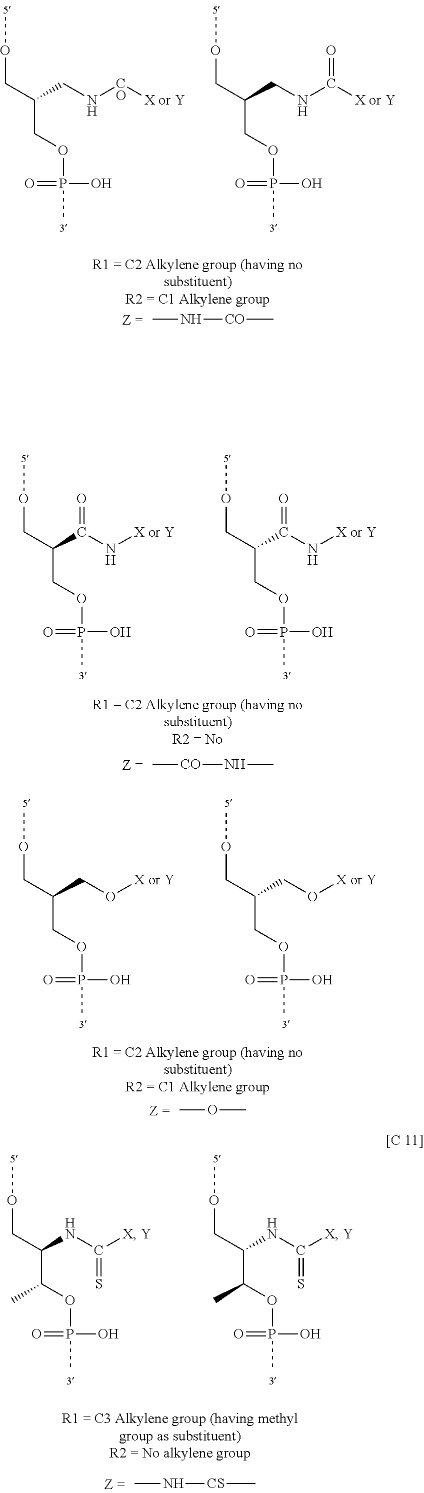

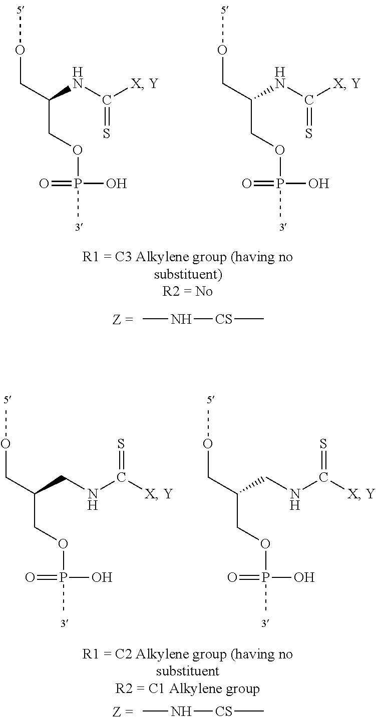

Such insulator unit and fluorescent label unit may be derivatized so that they are able to be linked to the backbone comprising a nucleobase in various forms. For example, they may be derivatized to amidite monomers.

When the labeling agent is formed by the backbone structure in the form of a duplex, each strand is preferably capable of forming a base pair(s) in such extent that the insulator is adjacent to the fluorescent label so that the reduction in quantum yield of the fluorescent label can be effectively suppressed by the insulator. The preferred number of the base pairs to be formed is not particularly limited; however it may be around 5 bp or more and 100 bp or less, although it may be varied depending on the number or arrangement of the fluorescent label and insulator.

The insulator unit is preferably provided in the backbone structure in the form of a single strand or duplex such that at least one insulator can be placed between two fluorescent labels. According to this configuration, electron transfer between more than one fluorescent labels can be suppressed to enhance fluorescence intensity. The insulator unit is preferably provided in the backbone structure in the form of a single strand or duplex such that at least one insulator can be placed on each side of one fluorescent label. According to this configuration, electron transfer between the fluorescent label and the nucleobase can be suppressed to enhance fluorescence intensity. It is also preferable that the insulator unit is provided in the backbone structure in the form of a single strand or duplex such that at least one insulator exists between the nucleobase and the fluorescent label.

FIGS. 1 to 4 show the exemplified configurations in which the fluorescent label unit and the insulator unit are provided in the backbone in the form of a single strand or duplex which forms a base pair(s). FIG. 1 shows the backbone structure in the duplex form formed by two independent single strands, which intends to suppress electron transfer to the adjacent nucleobase. FIG. 1A shows the configuration in which one or two or more insulator units are provided on each side of one fluorescent label unit in one backbone structure and no insulator unit is provided in the other backbone structure. FIG. 1B shows the configuration in which one or two or more insulator units comprised in one backbone structure are placed on each side of one fluorescent label unit in the other backbone structure. According to these configurations, the insulator can be adjacent to the fluorescent label. In addition, according to these configurations, the insulator can exist between the fluorescent label and the nucleobase.

FIG. 2 shows the configuration in the duplex form which intends to suppress electron transfer to the adjacent base similarly to the one shown in FIG. 1 and in which the insulator units are provided respectively on both of the backbone structures. Namely, FIGS. 2A and 2B show the configurations in which the insulator units are provided in both backbone structures such that these insulator units are adjacent on both sides of one fluorescent label unit in one backbone structure. One or two or more insulators are placed on each side of the fluorescent label. According to these configurations, the insulator can be adjacent to the fluorescent label as well as the insulator can exist between the fluorescent label and the nucleobase.

In FIG. 2C, the fluorescent label units are provided on both of one backbone structure and its complementary strand backbone structure and the insulator units are also provided on both of these backbone structures, so that the insulators of the insulator units provided in both strands are placed on both sides of the fluorescent labels arranged in these strands.

The configuration shown in FIG. 3 is in the form of a molecular beacon which is a single strand but has a loop and a stem capable of forming a duplex due to base pairing. In FIG. 3, the stem has the same structure as FIG. 2C.

FIG. 4 shows the configurations of the backbone structure in the duplex form. According to these configurations, the fluorescent label unit and the insulator unit are provided at a portion of the main chain or backbone overhanging from the duplex portion.

These exemplified configurations can be variously modified. In all configurations, the insulator adjacent to the fluorescent label may be placed either or both of the backbone structure and its complementary strand. The number of the insulators arranged adjacent to the nucleobase or between fluorescent labels may be one or more, e.g. two or more or three or more. The backbone and its complementary strand may form a complete duplex or these may be a single strand to form a duplex.

The labeling agent may comprise a component which allows its binding to a labeling target such as biological molecules. When the labeling target is protein, the labeling agent may contain a reactive group which can be covalently linked to a functional group in the protein selected from an amino, SH, carboxyl and hydroxyl groups. When the labeling target is nucleic acid, the labeling agent may contain a reactive group which can be covalently linked to such a functional group as described above in the nucleic acid or to a functional group introduced in the nucleic acid for binding. When the present labeling agent comprises the above backbone structure, labeling of a nucleic acid sample or an oligonucleotide which may be used as a probe, primer and the like is facilitated by providing a cohesive end to a part of the backbone structure or its complementary strand. The oligonucleotide or duplex oligonucleotide thus labeled maybe used as a labeled sample, a target nucleic acid which is to be detected, a primer, a probe or the like.

The labeling agent can be produced for example in conventional solid phase synthesis in which an amidite derivative capable of introducing the above units is used instead of an amidite derivative corresponding to a nucleotide. For example, in order to introduce the above units, an amino group of an aminoalkyl diol such as D-threoninol, 3-amino-1,2-propanediol is protected with an appropriate protective group such as an allyloxycarbonyl group, one hydroxyl group is then protected with dimethoxytrityl chloride followed by introduction to the other hydroxyl group of 2-cyanoethyl N,N,N′,N′-tetraisopropylphosphordiamidite to obtain an amidite derivative. This amidite derivative may be introduced with the fluorescent label or the insulator to obtain an amidite monomer. For example, for azobenzene compounds and perylene compounds, the methods may be applied such as those described in, for example, Nature Protocols, 2007, vol. 2, p. 203-212; Journal of the American Chemical Society, 2003, vol. 125, p. 2217-2223; and Tetrahedron Letters, 2007, vol. 48, p. 6759-6762. When the above monomer is obtained, an oligonucleotide can be synthesized which comprises the units linked with the fluorescent label or the insulator at a desired position according to a well known DNA synthesis method, e.g. the method described in Nature Protocols, 2007, vol. 2, p. 203-212.

The fluorescent label or the insulator may be introduced to an oligonucleotide which comprises the amidite derivative at a desired position whose amino group has been protected with an allyloxycarbonyl group or the like. For example, an oligonucleotide in which an amino group is still protected may be subjected to amino deprotection on a CPG support followed by introduction of a fluorophore by reaction with the fluorescent label or the insulator which is introduced with or carries a carboxylic or isocyanate group reactive with the amino group.

According to the above embodiments, the backbone structure having a nucleobase is also encompassed as an embodiment of the present invention, which comprises the insulator unit and the fluorescent label unit, the insulator unit existing between the nucleobase in the backbone structure and the fluorescent label unit. Typically, the backbone structure which may be an oligonucleotide and the like labeled with the labeling agent may be a nucleic acid sample, probe or primer. The backbone structure may be in the form of a single strand or duplex. The backbone structure may have one or two or more, preferably one fluorescent label unit between two insulator units. The backbone structure may contain the fluorescent label unit in the structure or at the end portion(s) (5′ terminal and/or 3′ terminal). Particularly, when the backbone structure comprises the complementary strand due to base pairing, the fluorescent label unit and the insulator unit may be both provided in the duplex or at the end portion(s) (5′ terminal and/or 3′ terminal) which is not a part of the duplex.

According to the above embodiments, the present disclosure also encompasses a compound (including an amidite compound) which allows formation of various backbone units containing the insulator. The compound comprising the insulator may have the following structure:

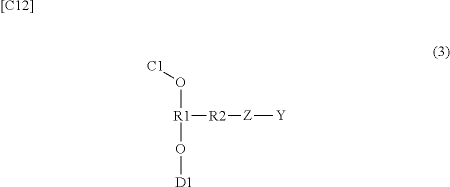

wherein Y represents the above molecule, R1 represents an optionally substituted alkylene chain having 2 or 3 carbon atoms, R2 represents an optionally substituted alkylene chain having 0 or more and 2 or less carbon atoms, Z represents a direct bond or a linking group, C1 represents a hydrogen atom or a hydroxyl protecting group and D1 represents a hydrogen atom, a hydroxyl protecting group, a phosphoramidite group or a linking group which is to be attached or has been attached to a solid support. As used herein, the phosphoramidite group comprises any phosphoramidite group which can be used for such a phosphoramidite method. R1, R2 and Z in the above formula are the same as described above.

In the above formula (3), C1 represents a hydrogen atom or a hydroxyl protecting group. The hydroxyl protecting group is not specifically limited and may be a well known hydroxyl protecting group including, for example, a fluorenylmethoxycarbonyl (FMOC), dimethoxytrityl (DMT), tert-butyldimethylsilyl (TBDMS), monomethoxytrityl, trifluoroacetyl, levulinyl or silyl group. Preferred protective group is a trityl group which may be selected from, for example, monomethoxytrityl (MMT), dimethoxytrityl (DMT) and tert-butyldimethylsilyl (TBDMS) groups.

D1 represents a hydrogen atom, a hydroxyl protecting group, a phosphoramidite group or a linking group which is to be attached or has been attached to a solid support. The compound (amidite compound) in which D1 is the phosphoramidite group can be used for synthesis of oligonucleotides by using the compound as a phosphoramidite reagent in the phosphoramidite method. According to the present invention, the phosphoramidite group may be represented by the following formula (4):

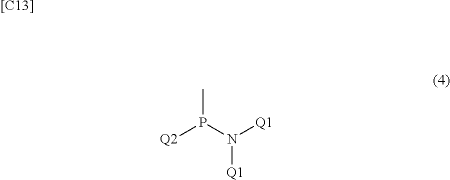

wherein a plurality of Q1 may be independently the same or different and each represents a branched or linear alkyl group having 1 to 5 carbon atoms and Q2 represents a branched or linear alkyl group having 1 to 5 carbon atoms or an optionally substituted alkoxyl group.

In the above formula, Q1 is not particularly limited; however it is preferably an isopropyl group. Q2 may include —OCH₂CH₂CN and the like. The phosphoramidite group may include, for example, the compound of the following formula (5):

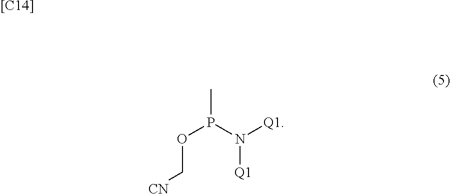

In the formula (3), the compound in which D1 is a linking group which is to be attached to a solid support is harbored on the solid support by attaching the linking group to a certain functional group on the solid support such as an amino group. In the formula (3), the compound in which D1 is a linking group which has been attached to a solid support can be used as a starting material for various nucleic acid solid phase synthesis methods because the present oligonucleotide is attached to the solid support via the linking group.

The present invention also provides a compound (amidite derivative) represented by the following formula B for production of the fluorescent label unit having perylenebisimide represented by the formula A:

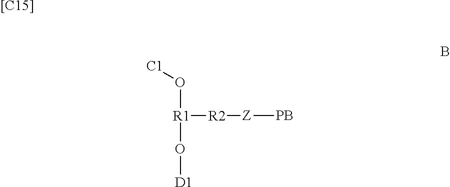

wherein PB represents the perylenebisimide represented by the above formula A, R1 represents an optionally substituted alkylene chain having 2 or 3 carbon atoms, R2 represents an optionally substituted alkylene chain having 0 or more and 2 or less carbon atoms, Z represents a direct bond or a linking group, C1 represents a hydrogen atom or a hydroxyl protecting group and D1 represents a hydrogen atom, a hydroxyl protecting group, a phosphoramidite group or a linking group which is to be attached or has been attached to a solid support. R1, R2, C1 and D1 in the formula B have the same meanings as those in the formula (3) and encompass various embodiments thereof which may be included in the formula (3).

### Method for Detection of Biological Molecule

The method for detection of the biological molecule disclosed herein may comprise the step of detecting the biological molecule according to a signal based on the fluorescent label of the present labeling agent. According to the present method for detection, the biological molecule can be detected with high sensitivity. The mode of detection of the biological molecule is not particularly limited. The biological molecule may be detected by labeling the biological molecule itself with the present labeling agent or it may be detected by using a detection reagent which is labeled and can specifically detect the biological molecule, such as an antibody, probe, primer and the like.

The present disclosure is more specifically described with the following examples, which, however, do not limit the present disclosure.

### EXAMPLE 1

### Synthesis of the Insulator Unit Linked to 4-Cyclohexyl Benzoic Acid (Insulator 1) and Formation of Its Amidite Monomer)

In the present example, the unit (the number of carbon atoms: 3) containing the insulator as shown below was synthesized and its amidite monomer was further synthesized according to the following scheme. In a 300-ml pear-shaped evaporating flask, D-threoninol (0.50 g, 4.6 mmol) was dissolved in 20 ml dimethylformamide (DMF), 4-cyclohexyl benzoic acid (1.04 g, 5.1 mmol) and 1-hydroxybenzotriazole (0.81 g, 6.0 mmol) were added and the mixture was stirred. Dicyclohexylcarbodiimide (1.24 g, 6.0 mmol) previously dissolved in 10 ml DMF was then added dropwise to the above DMF solution at room temperature. After overnight stirring at room temperature, the solvent was removed on an evaporator. Purification with silica gel column chromatography (developing solvent: chloroform:methanol=5:1) was carried out to obtain the compound 1-1.

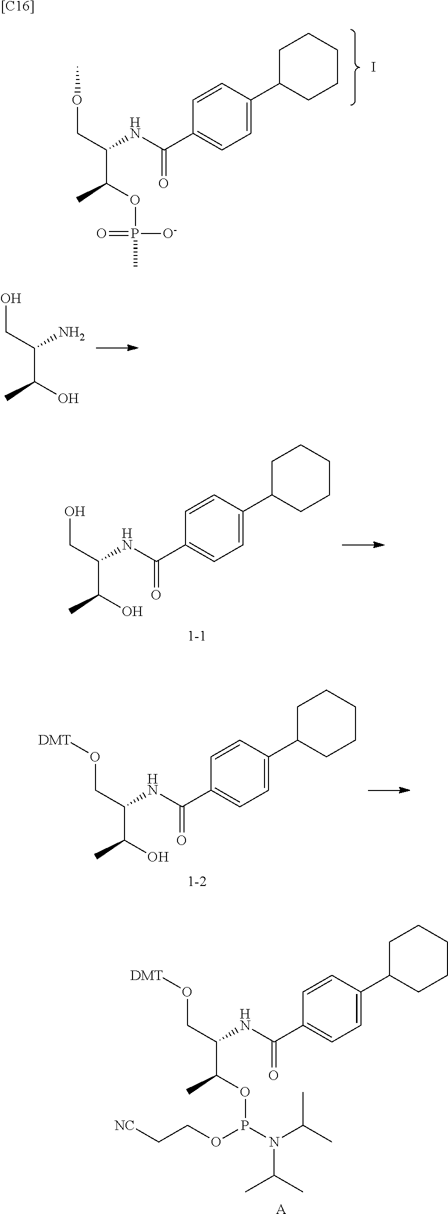

The obtained compound 1-1 (1.11 g, 3.81 mmol) was then taken into a 200-ml two-neck pear-shaped evaporating flask and dissolved in 30 ml dehydrated pyridine under nitrogen atmosphere. N,N-diisopropylethylamine (DIPEA: 1.0 mL, 5.71 mmol) was added thereto and the mixture was stirred. To a 50-ml two-neck pear-shaped evaporating flask were added dimethoxytrityl chloride (DMT-C1: 1.94 g, 5.71 mmol) and dimethylaminopyridine (DMAP: 0.058 g, 0.48 mmol) and dissolved in a solvent, 10 ml dehydrated dichloromethane. The dichloromethane solution was then slowly added dropwise to the above pyridine solution in an ice bath. After stirring for about 15 minutes in the ice bath, the solution was removed from the ice bath and kept under stirring at room temperature, and the reaction was terminated 3 hours after dropwise addition of the dichloromethane solution. The solvent was removed on an evaporator and purification with silica gel column chromatography (developing solvent: hexane:ethyl acetate:triethylamine=50:50:3) was carried out to obtain the compound 1-2.

The compound 1-2 (0.35 g, 0.59 mmol) was taken into a two-neck pear-shaped evaporating flask for azeotropic removal of water with 8 ml dehydrated acetonitrile for three times, dissolved in 30 ml dehydrated acetonitrile and further added with 2-cyanoethyl N,N,N′,N′-tetraisopropylphosphordiamidite (0.22 ml, 0.71 mmol) before stirring. 1H-tetrazole (0.054 g, 0.77 mmol) was taken into another two-neck pear-shaped evaporating flask for azeotropic removal of water with 8 ml dehydrated acetonitrile for three times, and then dissolved in 15 ml dehydrated acetonitrile. The 1H-tetrazole solution was added dropwise to the above solution of the compound 1-2 in acetonitrile in an ice bath and the mixture was stirred for about 15 minutes. The mixture was then removed from the ice bath and kept under stirring at room temperature. The reaction was terminated after about 1.5 hours. After removing the solvent by using an evaporator, the remained oily compound was dissolved in ethyl acetate. The ethyl acetate solution was shaken twice with a saturated sodium bicarbonate aqueous solution in a separating funnel followed by shaking with a saturated sodium chloride aqueous solution twice in a similar manner. After removal of water with magnesium sulfate, ethyl acetate was removed on an evaporator and purification with silica gel column chromatography (developing solvent: hexane:ethyl acetate:triethylamine=50:50:3) was carried out to obtain the compound A.

### EXAMPLE 2

### Synthesis of Fluorescent Label Unit and Insulator Unit

The fluorescent label unit comprising the fluorescent label (P: perylene), the insulator unit (compound B) comprising the insulator H and the insulator unit (compound C) comprising the insulator J as shown below were synthesized. These units were all synthesized in their amidite monomer forms for nucleic acid synthesis. The fluorescent label unit was obtained by the method described in Chemistry. An European Journal, 2010, vol. 16, p. 2479-2486 using the compound A and the compounds B and C were obtained in the same method as described in Example 1 except that trans-4-isopropylcyclohexane carboxylic acid and biphenyl-4-carboxylic acid were used as starting materials.

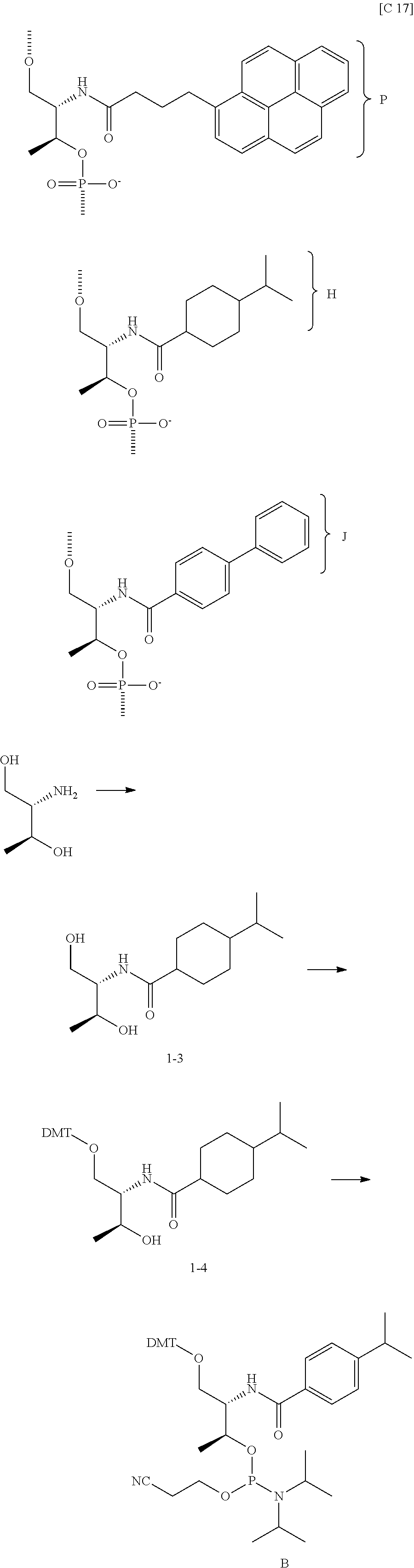

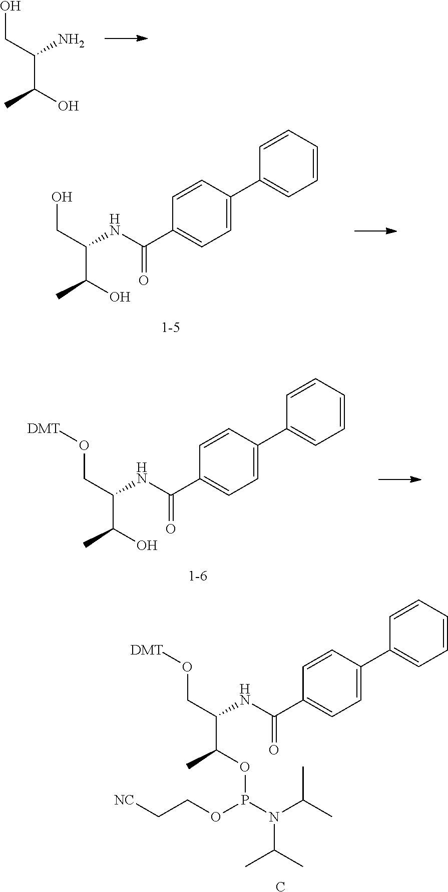

### EXAMPLE 3

### Synthesis of Oligonucleotides

In this example, the following oligonucleotides in which the fluorescent label unit and the insulator unit synthesized in Examples 1 and 2 were introduced.

[C 18]
PD1:
5′-GGTATCPGCAATC-3′
S0:
3′-CCATAGCGTTAG-5′
I1PA:
5′-GGTATCIPIGCAATC-3′
I1B:
3′-CCATAGIICGTTAG-5′
I3PA:
5′-GGTATCIIIPIIIGCAATC-3′
I3B:
3′-CCATAGIIIIIICGTTAG-5′
H1PA:
5′-GGTATCHPHGCAATC-3′
H1B:
3′-CCATAGHHCGTTAG-5′
H3PA:
5′-GGTATCHHHPHHHGCAATC-3′
H3B:
3′-CCATAGHHHHHHCGTTAG-5′
J1PA:
5′-GGTATCJPJGCAATC-3′
J1B:
3′-CCATAGJJCGTTAG-5′

Introduction of the fluorescent label and the insulator to the oligonucleotides was carried out by the method of the following scheme via a phosphoramidite monomer protected with an allyloxycarbonyl group.

Namely, in ABI type 3400 DNA synthesizer, phosphoramidite monomers corresponding to four natural bases and the amidite monomers comprising the above fluorescent label and the insulator were appropriately used to extend DNA strands having given sequences on a controlled pore glass (CPG) support. The CPG support (10 mg, 0.45 μmol) was weighed in a plastic syringe attached with a filter and washed three times with 1 mL acetonitrile and then three times with 1 mL dichloromethane. The desired DNA was separated from the CPG support and purified by high performance liquid chromatography according to the method described in Nature Protocols, 2007, vol. 2, p. 203-212.

### EXAMPLE 4

### Measurement of Fluorescence Intensity of Duplex Oligonucleotides

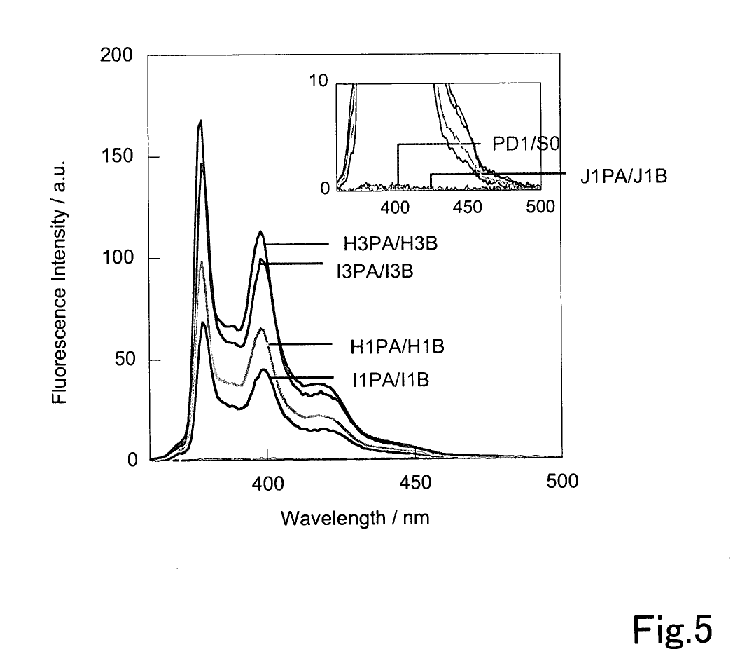

Respective oligonucleotides synthesized in Example 3 were combined into duplexes as follows to obtain six duplex oligonucleotides in total. These oligonucleotides were measured for fluorescence intensity under the following conditions. The results are shown in FIG. 5.
DNA: 1.0 μmol/l
Sodium chloride: 0.1 mol/l
Phosphate buffer: 10 mmol/l (pH 7.0)

As shown in FIG. 5, it was found that the insulator I or H is effective as the insulator. On the other hand, the insulator J was not effective. Based on these results, it was found that the ring entity of nonplanar structure is effective for suppression of quenching. Fluorescence quantum yield of PD1/S0 was 0.01 or lower while those of Il PA/11B and I3PA/I3B were 0.16 and 0.44 respectively, indicating an increase in fluorescence quantum yield by a few hundred times. It was also found that the effect of the insulator is increased when the number of the insulators is increased.

### EXAMPLE 5

### Synthesis of Oligonucleotides

In this example, the fluorescent label unit (amidite monomer) containing perylenebisimide (B) as the fluorescent label was synthesized, which was then used together with the insulator units (amidite monomers) having the insulators I and H to synthesize the following oligonucleotides according to the method described in Example 4.

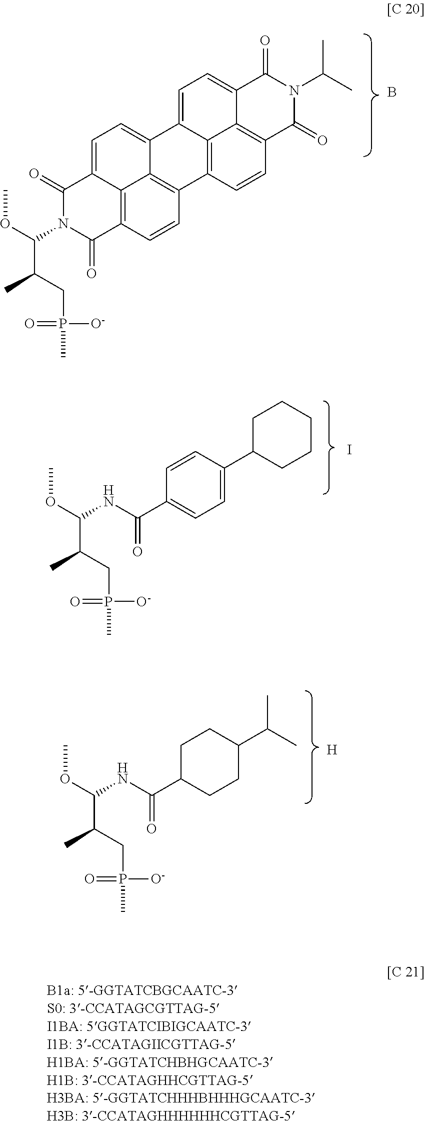

The fluorescent label unit amidite monomer (compound D) was synthesized as follows:

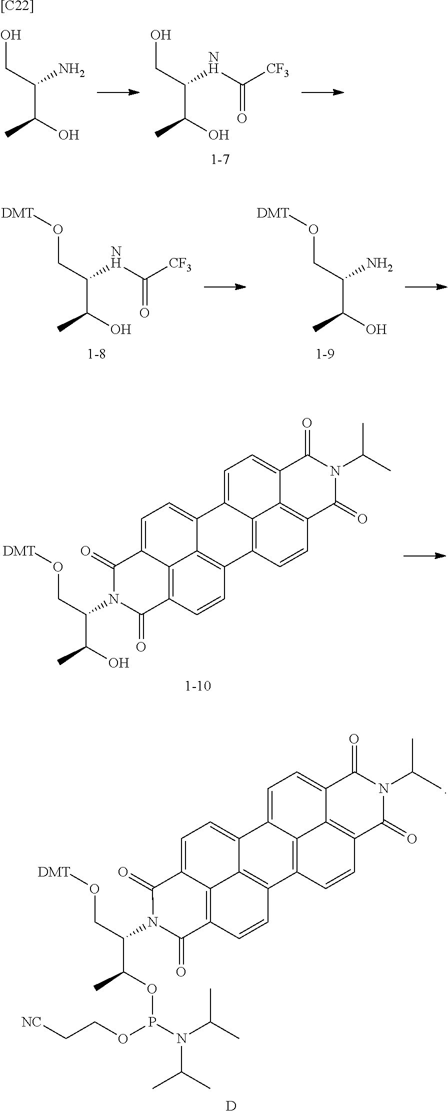

### Formation of Amidite Monomer by Attaching Perylenebisimide to D-threoninol

In this example, the amidite monomer (compound A) of the unit (the number of carbon atoms: 3) linked to the fluorescent label was synthesized according to the following scheme. In a 100-ml pear-shaped evaporating flask, D-threoninol (1.00 g, 9.51 mmol) was dissolved in 15 ml dehydrated methanol and the mixture was stirred. Ethyl trifluoroacetate (1.25 ml, 10.5 mmol) was then added dropwise to the above methanol solution in an ice bath. After stirring in the ice bath for 2 hours, the solvent was removed on an evaporator to obtain the compound 1-7.

The obtained compound 1-7 (1.76 g, 8.75 mmol) was then taken into a 200-ml two-neck pear-shaped evaporating flask and dissolved in 20 ml dehydrated pyridine under nitrogen atmosphere. N,N-diisopropylethylamine (DIPEA: 1.74 mL, 10.5 mmol) was added thereto and the mixture was stirred. To a 100-ml two-neck pear-shaped evaporating flask were added dimethoxytrityl chloride (DMT-C1: 3.56 g, 10.5 mmol) and dimethylaminopyridine (DMAP:0.16 g, 1.31 mmol) under nitrogen atmosphere and dissolved in a solvent, 15 ml dehydrated dichloromethane. The dichloromethane solution was then slowly added dropwise to the above pyridine solution in an ice bath. After stirring for about 15 minutes in the ice bath, the solution was removed from the ice bath and kept under stirring at room temperature, and the reaction was terminated 3 hours after dropwise addition of the dichloromethane solution. The solvent was removed on an evaporator and purification with silica gel column chromatography (developing solvent: hexane:ethyl acetate:triethylamine=80:20:3) was carried out to obtain the compound 1-8.

The compound 1-8 (3.61 g, 7.17 mmol) was taken into a 200-ml pear-shaped evaporating flask and dissolved in 60 ml methanol. This solution was added with 120 ml of a 28% ammonia solution and stirred overnight at room temperature. The solvent was removed on an evaporator to obtain the compound 1-9.

The compound 1-9 (0.676 g, 1.66 mmol), zinc acetate dihydrate (0.729 g, 3.32 mmol) and 3,4,9,10-perylenetetracarboxylic acid dianhydride (0.651 g, 1.66 mmol) were taken into a 200-ml two-neck pear-shaped evaporating flask and dissolved in 100 ml dehydrated pyridine under nitrogen atmosphere. The solution was added with triethylamine (3.45 mL, 10.5 mmol) and refluxed at 90° C. for 12 hours. The solution was added with isopropylamine (2.84 ml, 33.2 mmol) under nitrogen atmosphere and refluxed for further 16 hours. After removing the solvent by using an evaporator, purification with silica gel column chromatography (developing solvent: hexane:chloroform:triethylamine=50:50:3) was carried out to obtain the compound 1-10.

The compound 1-10 (0.16 g, 0.19 mmol) was taken into a two-neck pear-shaped evaporating flask for azeotropic removal of water with 8 ml dehydrated acetonitrile for three times, dissolved in 30 ml dehydrated acetonitrile and further added with 2-cyanoethyl N,N,N′,N′-tetraisopropylphosphordiamidite (0.08 ml, 0.25 mmol) before stirring. 1H-tetrazole (0.018 g, 0.25 mmol) was taken into another two-neck pear-shaped evaporating flask for azeotropic removal of water with 8 ml dehydrated acetonitrile for three times, and then dissolved in 15 ml dehydrated acetonitrile. The 1H-tetrazole solution was added dropwise to the above solution of the compound 1-10 in acetonitrile in an ice bath and the mixture was stirred for about 15 minutes. The mixture was then removed from the ice bath and kept under stirring at room temperature. The reaction was terminated after about 1.5 hours. After removing the solvent by using an evaporator, the remained oily compound was dissolved in ethyl acetate. The ethyl acetate solution was shaken twice with a saturated sodium bicarbonate aqueous solution in a separating funnel followed by shaking with a saturated sodium chloride aqueous solution twice in a similar manner. After removal of water with magnesium sulfate, ethyl acetate was removed on an evaporator and purification with silica gel column chromatography (developing solvent: hexane:ethyl acetate:triethylamine=60:40:3) was carried out to obtain the compound D.

### EXAMPLE 6

### Measurement of Fluorescence Intensity of Duplex Oligonucleotides

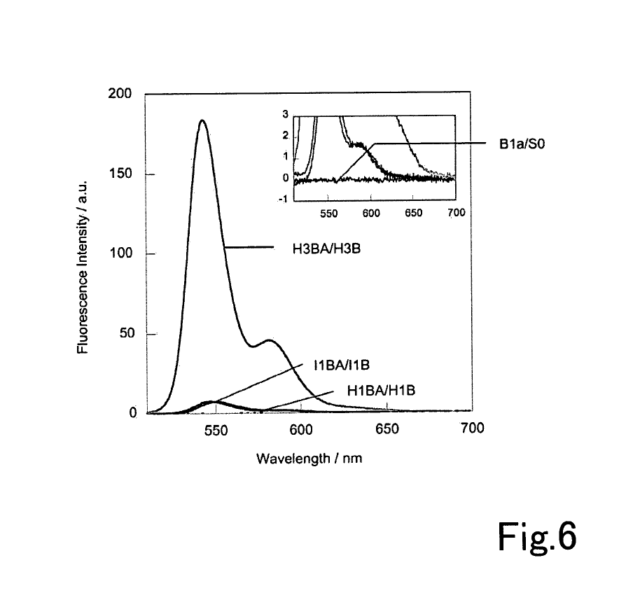

Respective oligonucleotides synthesized in Example 5 were combined into B1a/S0, 11BA/11B, H1BA/H1B and H3BA/H3B to prepare duplex oligonucleotides. These oligonucleotides were measured for fluorescence intensity under the following conditions. The results are shown in FIG. 6.
DNA: 1.0 μmol/l
Sodium chloride: 0.1 mol/l
Phosphate buffer: 10 mmol/l (pH 7.0)

As shown in FIG. 6, it was found that the insulators H and I were also effective for this fluorescent label (perylenebisimide). Particularly, it was found that when three insulator units were arranged on each side of the fluorescent label, quantum yield increased by 1000 times or more. Based on these results, it was found that the insulator units I and H are effective as the insulators. It was also found that the effect of the insulator is increased with increase in the number of the insulators. Perylenebisimide is characterized in that it is photochemically stable and highly resistant to photobleaching compared to other fluorescent dyes. This dye can also be combined with the insulator to obtain quantum yield equivalent to or higher than that of other fluorescent dyes.

### EXAMPLE 7

### Synthesis of Oligonucleotides

In this example, the fluorescent label unit and the insulator unit (compounds A and B) prepared in Examples 1 and 2 were used to synthesize the following oligonucleotides according to the method described in Example 3.

[C 23]
HPH11c:
5′-GATGHPHHPHHGCCGAACTGAAGATACGC-3′
HPH11d:
3′-CTACHHPHHPHCGGC-5′
IPI11c:
5′-GATGIPIIPIIGCCGAACTGAAGATACGC-3′
IPI11d:
3′-CTACIIPIIPICGGC-5′
P1c:
5′-PAACTGAAGATACGC-3′
Target
T5N:
3′-TTGACTTCTATGCG-5′

### EXAMPLE 8

### Measurement of Fluorescence Intensity of Duplex Oligonucleotides

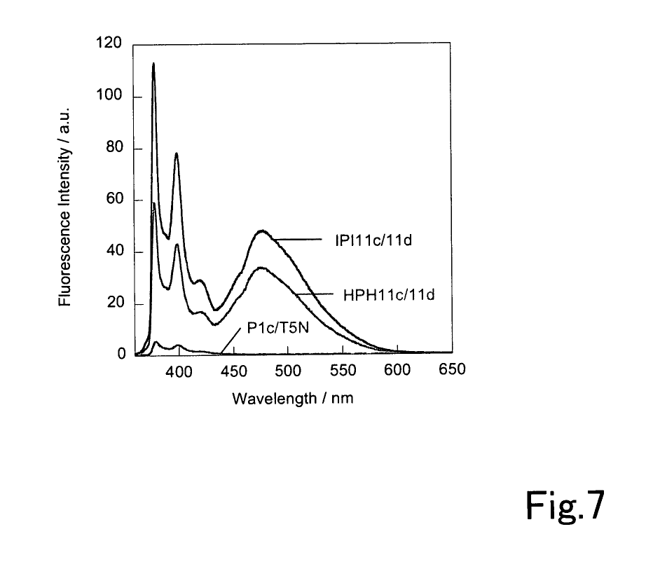

Respective oligonucleotides synthesized in Example 7 were combined in the following combinations to prepare duplex oligonucleotides. These oligonucleotides were measured for fluorescence intensity under the following conditions. The results are shown in FIG. 7. Luminescence amount was also measured and the results are shown below.
DNA: 1.0 μmol/l
Sodium chloride: 0.1 mol/l
Phosphate buffer: 10 mmol/l (pH 7.0)

As shown in FIG. 7, placing the insulator H or I on both sides of the respective multiple fluorescent labels (pyrene) resulted in about 20 times increase in fluorescence intensity. As shown in Table 1, luminescence amount (peak area) including excimer luminescence increased by about 28 times.

TABLE 1

| | IPI11c/IPI11d | HPH11c/HPH11d | P1c/T5N |
|---|---|---|---|
| Peak area | 333424 | 209489 | 12050.3 |
| Ratio | 27.7 | 17.4 | 1.0 |

### EXAMPLE 9

### Synthesis of Oligonucleotides Comprising Insulator Unit and Fluorescent Label

The oligonucleotide containing the insulator H and the fluorescent label, FITC, was synthesized by a scheme in which FITC was introduced to the oligonucleotide synthesized via a phosphoramidite monomer protected with an allyloxycarbonyl group. In ABI type 394 DNA synthesizer, the insulator unit (compound B) comprising the insulator H prepared in Example 2, the phosphoramidite monomer A in which an amino group of D-threoninol is protected with the allyloxycarbonyl group and phosphoramidite monomers corresponding to four natural bases were used to synthesize the oligonucleotides F1H0p (5′-FGGCAGCGTAGGTCCT-3′) and F1H2p (5′-HFHGGCAGCGTAGGTCCT-3′) in which the phosphoramidite monomer A was placed at the site corresponding to FITC. Using commercially available phosphoramidite monomers corresponding to four natural bases, the complementary strand q (3′-CCGTCGCATCCAGGA-5′) was also synthesized.

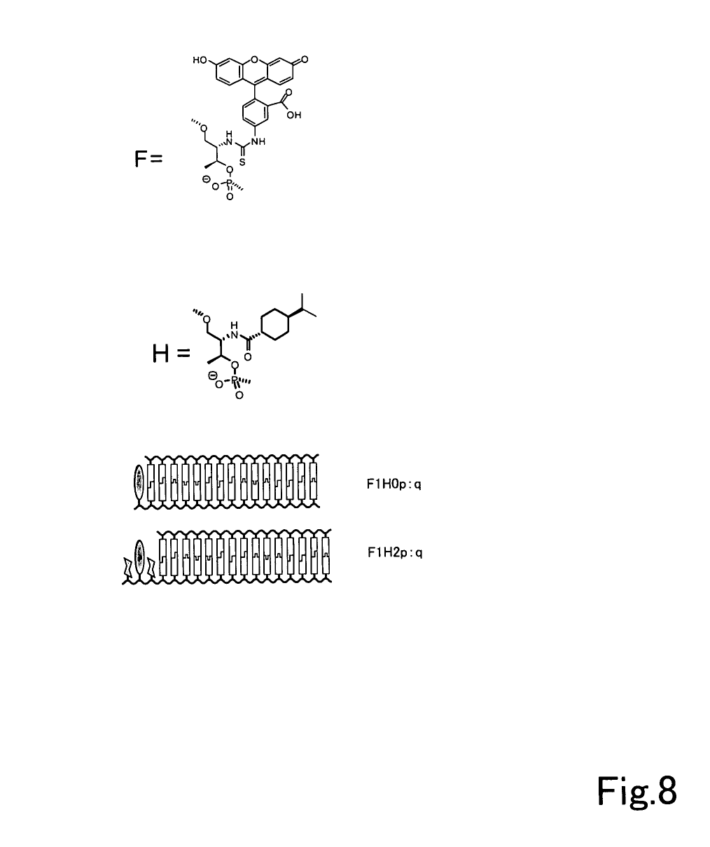

Configurations of the duplex oligonucleotides obtained by base pairing the p oligonucleotides and the complementary strand q are shown in FIG. 8.

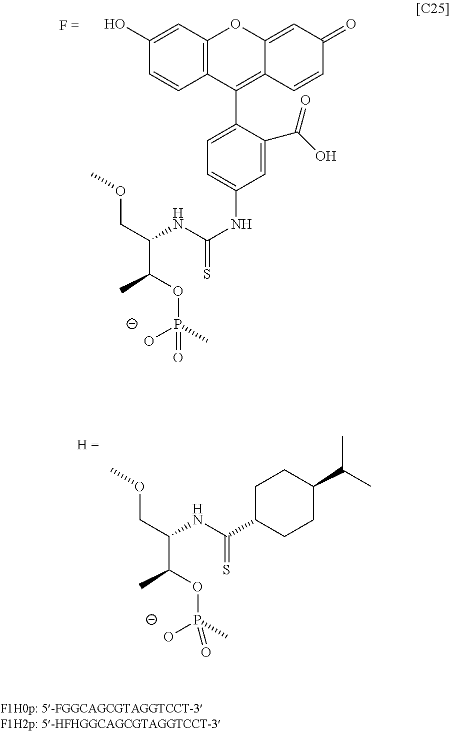

F: Fluorescent dye (FITC)
H: Insulator (trans-isopropylcyclohexane)
Complementary strand q: 3′-CCGTCGCATCCAGGA-5′

Namely, oligonucleotides having given sequences were extended on a controlled pore glass (CPG) support. The CPG support (10 mg, 0.45 μmol) was weighed in a plastic syringe attached with a filter and washed three times with 1 mL acetonitrile and then three times with 1 mL dichloromethane. A Pd(Ph₃)₄ (5.2 mg, 4.5 μmol) solution (500 μL) in dichloromethane was then added to 48.8 μL N-methylaniline (450 μmol) and this mixture was added to the above CPG support for incubation at 35° C. for 3 hours to deprotect the allyloxycarbonyl group only on the CPG support.

To a FITC (14.02 mg, 18 μmol) solution in DMF (500 μL) was added DIPEA (6.12 μl, 18 μmol) and this mixture was added to the CPG support (10 mg, 0.36 μmol) in which the allyloxycarbonyl group only was deprotected followed by stirring for 3 days. After removing the reaction solution by filtration, the CPG support was washed by adding 1 mL of a 0.1 M PPTS solution in DMF to the syringe and shaking it for 1 minute. The support was further washed with 1 mL DMF for three times and then with 1 ml dichloromethane for three times to obtain the FITC-introduced CPG support.

DNA was then separated from the CPG support and purified by high performance liquid chromatography according to the method described in Nature Protocols, 2007, vol. 2, p. 203-212, thereby separation-purifying the oligonucleotides comprising the desired insulator and FITC.

The phosphoramidite monomer A in which the amino group of D-threoninol was protected with the allyloxycarbonyl group was synthesized according to the following scheme. In a 300-ml pear-shaped evaporating flask, D-threoninol (0.99 g, 9.41 mmol) was dissolved in 75 ml tetrahydrofuran (THF), 15 ml triethylamine was added and the mixture was stirred. Allyl chloroformate (1.01 ml, 9.51 mmol) previously dissolved in 75 ml THF was then added dropwise to the above THF solution in an ice bath. After 15 minutes, the solution was removed from the ice bath and kept under stirring at room temperature and the reaction was terminated 1.5 hours after completion of dropwise addition of the THF solution. The solvent was then removed on an evaporator and purification with silica gel column chromatography (developing solvent: chloroform:methanol=3:1) was carried out to obtain the compound 1-1.

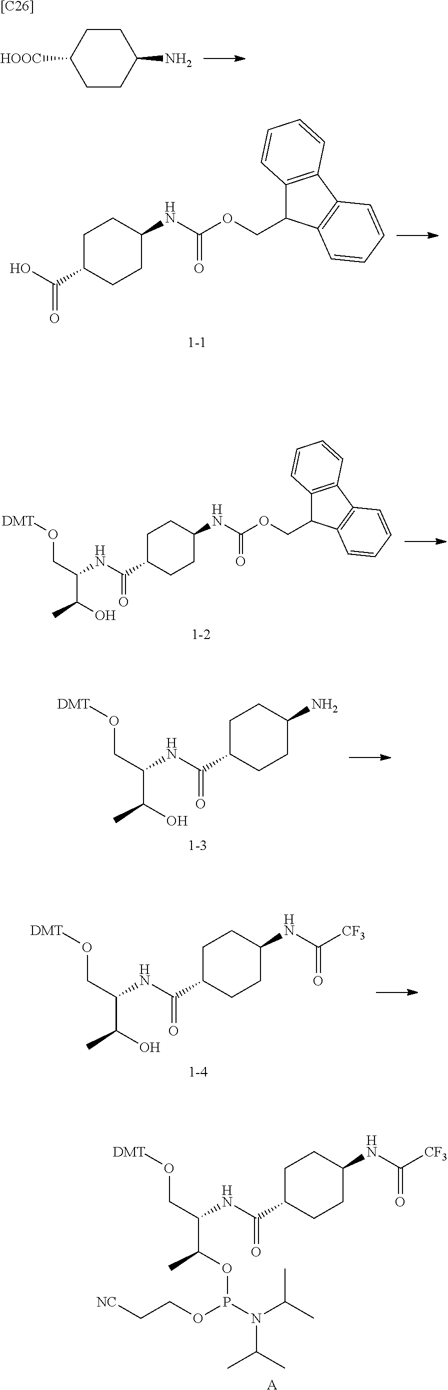

The obtained compound 1-1 (1.72 g, 9.09 mmol) was taken into a 200-ml two-neck pear-shaped evaporating flask and dissolved in 30 ml dehydrated pyridine under nitrogen atmosphere. N,N-diisopropylethylamine (DIPEA: 1.54 mL, 9.09 mmol) was added thereto and the mixture was stirred. To a 50-ml two-neck pear-shaped evaporating flask were added dimethoxytrityl chloride (DMT-C1: 3.08 g, 9.09 mmol) and dimethylaminopyridine (DMAP:0.14 g, 1.14 mmol) and dissolved in a solvent, 10 ml dehydrated dichloromethane. The dichloromethane solution was then slowly added dropwise to the above pyridine solution in an ice bath. After stirring for about 15 minutes in the ice bath, the solution was removed from the ice bath and kept under stirring at room temperature, and the reaction was terminated 4.5 hours after dropwise addition of the dichloromethane solution. The solvent was removed on an evaporator and purification with silica gel column chromatography (developing solvent: hexane:ethyl acetate:triethylamine=66:33:3) was carried out to obtain the compound 1-2.

The compound 1-2 (0.74 g, 1.51 mmol) was taken into a two-neck pear-shaped evaporating flask for azeotropic removal of water with 8 ml dehydrated acetonitrile for three times, dissolved in 30 ml dehydrated acetonitrile and further added with 2-cyanoethyl N,N,N′,N′-tetraisopropylphosphordiamidite (0.54 g, 1.79 mmol) before stirring. 1H-tetrazole (0.137 g, 1.51 mmol) was taken into another two-neck pear-shaped evaporating flask for azeotropic removal of water with 8 ml dehydrated acetonitrile for three times, and then dissolved in 15 ml dehydrated acetonitrile. The 1H-tetrazole solution was added dropwise to the above solution of the compound 1-2 in acetonitrile in an ice bath and the mixture was stirred for about 15 minutes. The mixture was then removed from the ice bath and kept under stirring at room temperature. The reaction was terminated after about 1.5 hours. After removing the solvent by using an evaporator, the remained oily compound was dissolved in ethyl acetate. The ethyl acetate solution was shaken twice with a saturated sodium bicarbonate aqueous solution in a separating funnel followed by shaking with a saturated sodium chloride aqueous solution twice in a similar manner. After removal of water with magnesium sulfate, ethyl acetate was removed on an evaporator and purification with silica gel column chromatography (developing solvent: hexane:ethyl acetate:triethylamine=50:50:3) was carried out to obtain the phosphoramidite monomer A.

### EXAMPLE 10

### Measurement of Fluorescence Intensity of Duplex Oligonucleotides

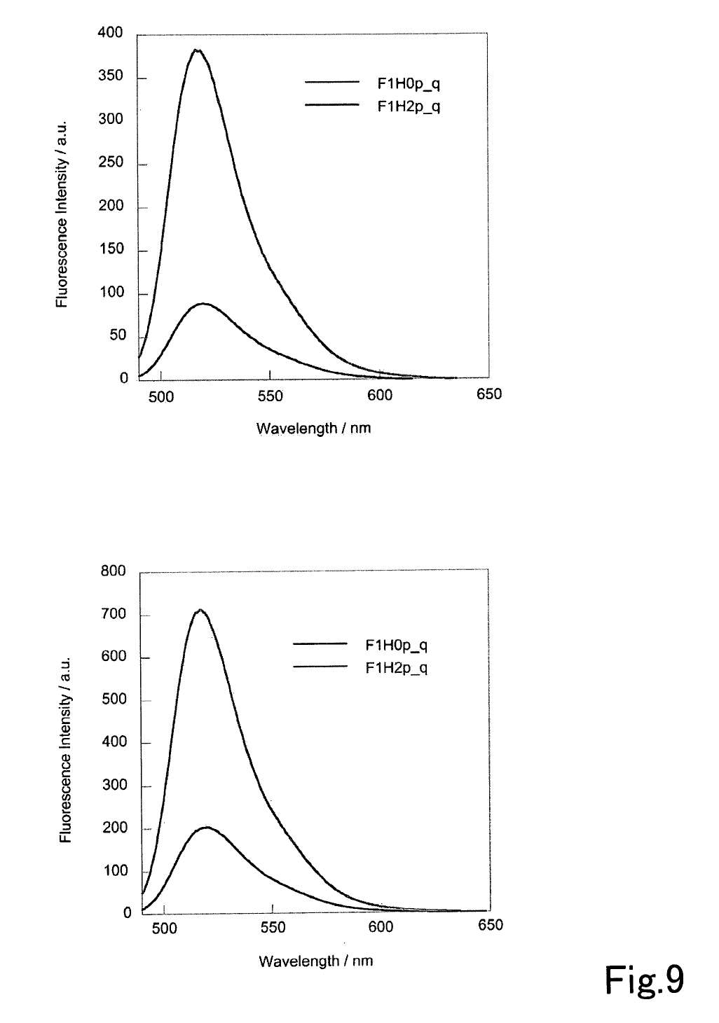

Respective oligonucleotides synthesized in Example 9 were combined in the combinations described in FIG. 8 to prepare duplex oligonucleotides. These oligonucleotides were measured for fluorescence intensity under two different pH conditions (pH 7 and pH 9). The results are shown in FIG. 9.

Condition 1: pH 7
DNA: 1.0 μmol/l
Sodium chloride: 0.1 mol/l
Phosphate buffer: 10 mmol/l (pH 7.0)
Temperature: 20° C.
Condition 2: pH 9
DNA: 1.0 μmol/l
Sodium chloride: 0.1 mol/l
Tris buffer: 10 mmol/l (pH 9.0)
Temperature: 20° C.

As shown in FIG. 9, fluorescence intensity of the oligonucleotides in which the insulators (H) were introduced on both sides of FITC was increased by about 4 times compared to the oligonucleotides having one molecule of FITC under pH 7 and pH 9. Based on these results, it was found that fluorescence intensity for the fluorescent dyes such as FITC whose fluorescence intensity varies depending on pH can be stably enhanced at pH ranging from neutral (about pH 7) to alkaline (about pH 9). Accordingly, for this type of fluorescent dyes, pH condition upon measurement of fluorescence intensity can be selected with greater flexibility and therefore the operation of pH adjustment during the procedures from hybridization to fluorescence intensity measurement can be simplified or omitted.

### EXAMPLE 11

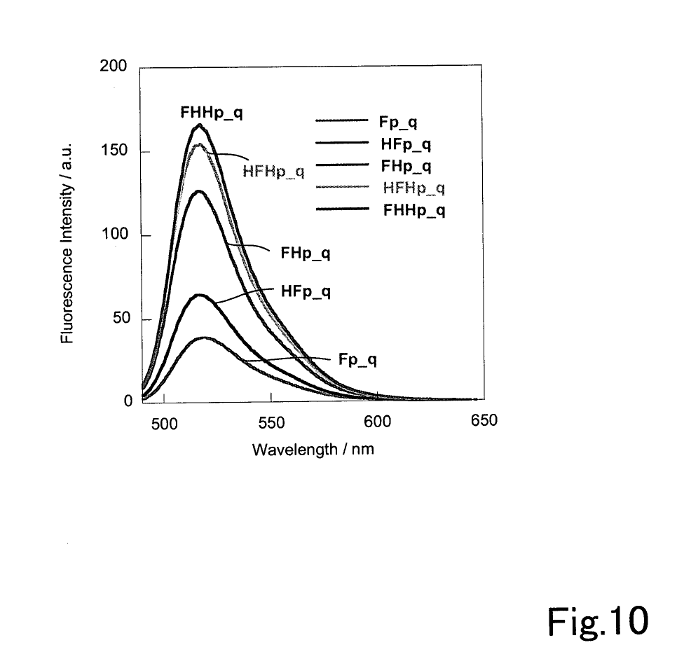

In this example, the units which were already prepared were used to synthesize the following oligonucleotides. These oligonucleotides were measured for fluorescence intensity under the following conditions. The results are shown in FIG. 10.

Fp
5′-FGGCAGCGTAGGTCCT-3′
HFHp
5′-HFHGGCAGCGTAGGTCCT-3′
HFp
5′-HFGGCAGCGTAGGTCCT-3′
FHp
5′-FHGGCAGCGTAGGTCCT-3′
FHHp
5′-FHHGGCAGCGTAGGTCCT-3′
q (Target)
3′-CCGTCGCATCCAGGA-5′ (DNA)

### Measurement Condition

DNA: 1.0 μmol/l
Sodium chloride: 0.1 mol/l
Phosphate buffer: 10 mmol/l (pH 7.0)

As shown in FIG. 10, flanking the fluorescent dye with the insulators resulted in the highest fluorescence intensity. The second highest fluorescence intensity was obtained when the fluorescent dye and a normal base were separated by two insulators.

### EXAMPLE 12

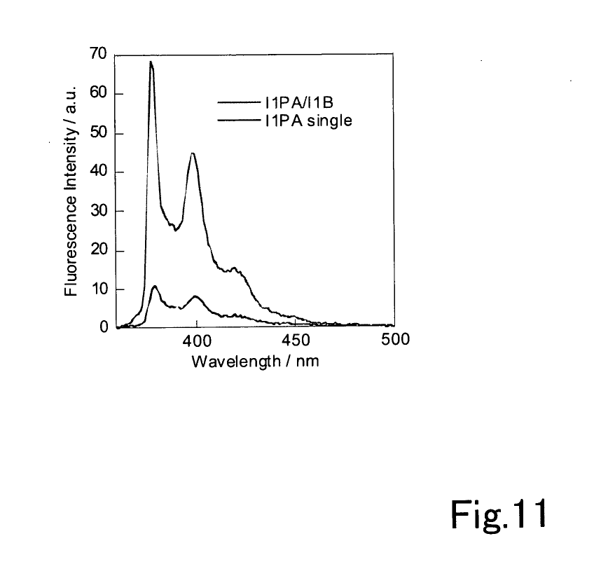

In this example, the units which were already prepared were used to synthesize the following oligonucleotides. These oligonucleotides in the forms of a single strand (I1PA only) and duplex were measured for fluorescence intensity under the following conditions. The results are shown in FIG. 11.

I1PA
5′-GGTATCIPIGCAATC-3′
I1B
3′-CCATAGIICGTTAG-3′

DNA: 1.0 μmol/l
Sodium chloride: 0.1 mol/l
Phosphate buffer: 10 mmol/l (ph 7.0)

As shown in FIG. 11, the labeling agent (structure) in the form of a duplex showed higher effect than the labeling agent (structure) in the form of a single strand.

1. A suppressing agent of electron transfer, comprising:
a ring entity of nonplanar structure which comprises an optionally substituted monocyclic alkane having 4 or more and 7 or less carbon atoms,
wherein said electron transfer contains the electron transfer between fluorescent labels or between and a fluorescent label and an nucleobase, said fluorescent label is linked to a backbone structure having a nucleobase and the ring entity is arranged so as to be adjacent to said fluorescent label.

2. The suppressing agent according to claim 1, wherein said ring entity is arranged so as to be adjacent to the fluorescent labels on both sides thereof.

3. The suppressing agent according to claim 1, which comprises said ring entity is linked to the backbone structure or a complementary strand of the backbone structure.

4. The suppressing agent according to claim 1, wherein said monocyclic alkane comprises cyclohexane derivative.

5. The suppressing agent according to claim 4, wherein said ring entity is selected from the group consisting of:

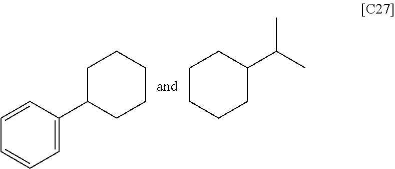

6. A labeling agent comprising:
one or two or more fluorescent label units, each of which contains a fluorescent label; and
one or two or more insulator units for suppressing electron transfer containing molecules, each of which has a ring entity of nonplanar structure which comprises a monocyclic alkane having 4 or more and 7 or less carbon atoms,
wherein said one or two or more fluorescent label units are linked to a backbone structure having a nucleobase,
said one or two or more insulator units are linked to the backbone structure or a complementary strand of the backbone structure,
said electron transfer includes the electron transfer between the fluorescent labels or between and the fluorescent label and the nucleobase, and
said one or more insulator units are arranged between the two fluorescent label units or between the fluorescent label unit and the nucleobase.

7. The labeling agent according to claim 6, wherein said two insulator unit are arranged so as to be adjacent to said one fluorescent unit at both sides thereof.

8. The labeling agent according to claim 6, wherein said backbone structure includes a phosphate-saccharide chain backbone and/or a phosphate-alkylene chain.

9. The labeling agent according to claim 6, wherein the fluorescent label unit is represented by the following formula (1): 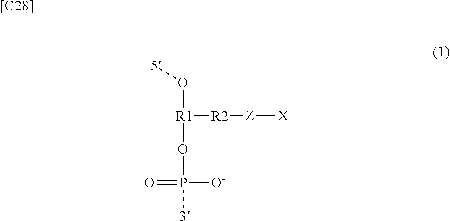
where X represents a fluorescent label, R1 represents an optionally substituted alkylene chain having 2 or 3 carbon atoms, R2 represents a direct bond or an optionally substituted alkylene chain having 1 to 2 carbon atoms, and Z represents a direct bond or a linking group.

10. The labeling agent according to claim 6, wherein the insulator unit is represented by the following formula (2): 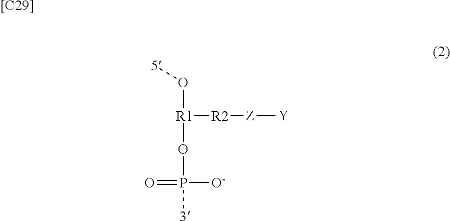
where Y represents an insulator, R1 represents an optionally substituted alkylene chain having 2 or 3 carbon atoms, R2 represents a direct bond or an optionally substituted alkylene chain having 1 to 2 carbon atoms, and Z represents a direct bond or a linking group.

11. The labeling agent according to claim 6, wherein the fluorescent label is selected from the group consisting of cyanine-based dyes, merocyanine-based dyes, condensed aromatic ring-based dyes, xanthene-based dyes, coumarin-based dyes and acridine-based dyes.

12. A labeled oligonucleotide which comprises the labeling agent according to claim 6 as a part thereof.

13. A material for suppressing agent of electron transfer which comprises a ring entity of nonplanar structure which comprise an optionally substituted monocyclic alkane having 4 or more and 7 or less carbon atoms and which is represented by the following formula (3): 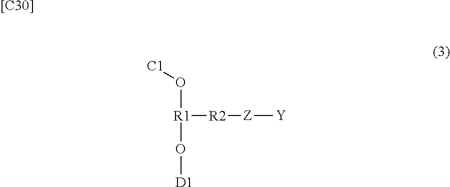
where Y represents the ring entity, R1 represents an optionally substituted alkylene chain having 2 or 3 carbon atoms, R2 represents an optionally substituted alkylene chain having 0 to 2 carbon atoms, Z represents a direct bond or a linking group, C1 represents a hydrogen atom or a hydroxyl protecting group, and D1 represents a hydrogen atom, a hydroxyl protecting group, a phosphoramidite group or a linking group which is to be attached or has been attached to a solid support.

14. The material for suppressing agent of electron transfer according to claim 13, said ring entities are selected from the group consisting of:

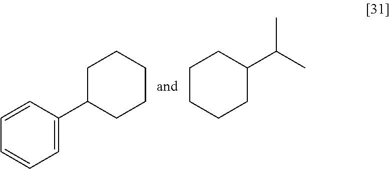

15. A method for detection of a biological molecule, the method comprising;
detecting a biological molecule according to a signal based on the fluorescent label of the labeling agent according to claim 6.

16. A method for production of a fluorescent labeled oligonucleotide, the method comprising:
synthesizing an oligonucleotide including the labeling agent according to claim 6.


SEQUENCE LISTING (6 sequences)

SEQ ID NO: 1 - DNA, 12 bp, Artificial Sequence
  Synthetic Construct - Probe
gattgcgatacc

SEQ ID NO: 2 - DNA, 18 bp, Artificial Sequence
  Synthetic Construct - Probe
gccgaactgaagatacgc

SEQ ID NO: 3 - DNA, 14 bp, Artificial Sequence
  Synthetic Construct - Probe
aactgaagatacgc

SEQ ID NO: 4 - DNA, 14 bp, Artificial Sequence
  Synthetic Construct - Probe
gcgtatcttcagtt

SEQ ID NO: 5 - DNA, 15 bp, Artificial Sequence
  Synthetic Construct - Probe
ggcagcgtaggtcct

SEQ ID NO: 6 - DNA, 15 bp, Artificial Sequence
  Synthetic Construct - Probe
aggacctacgctgcc